(19) United States
(12) Patent Application Publication
(10) Pub. No.: US 2023/0178709 A1
(43) Pub. Date: Jun. 8, 2023

(54) DELITHIATION SOLUTION AND METHOD FOR FORMATION OF ANODE ACTIVE MATERIAL OR ANODE USING SAME

(71) Applicant: KOREA INSTITUTE OF SCIENCE AND TECHNOLOGY, Seoul (KR)

(72) Inventors: Minah LEE, Seoul (KR); Jihyun HONG, Seoul (KR); Hun-Gi JUNG, Seoul (KR); Jin Kwan CHOI, Seoul (KR)

(73) Assignee: KOREA INSTITUTE OF SCIENCE AND TECHNOLOGY, Seoul (KR)

(21) Appl. No.: 17/741,660

(22) Filed: May 11, 2022

(30) Foreign Application Priority Data
Dec. 8, 2021 (KR) 10-2021-0174920

(51) Int. Cl. H01M 4/04; H01M 4/38; H01M 4/587; H01M 10/0525

(52) U.S. Cl. CPC H01M 4/049; H01M 4/386; H01M 4/587; H01M 10/0525; H01M 2004/027

(57) ABSTRACT

The present disclosure relates to a delithiation solution and a method for forming an anode active material or an anode using the same. By chemically extracting reactive lithium from a high-capacity anode active material or anode, which has high initial coulombic efficiency due to high lithium content but exhibits decreased stability in dry air or in a solvent for preparation of a slurry, stability can be improve and initial coulombic efficiency can be maintained high. In addition, the method for forming an anode active material or an anode according to the present disclosure can greatly reduce the cost and time required for delivery after production of a lithium-ion battery.

### CROSS-REFERENCE TO RELATED APPLICATION

This application claims priority to Korean Patent Application No. 10-2021-0174920, filed on Dec. 8, 2021, and all the benefits accruing therefrom under 35 U.S.C. § 119, the contents of which in its entirety are herein incorporated by reference.

### BACKGROUND

### 1. Field

The present disclosure relates to a delithiation solution and a method for forming an anode active material or an anode using the same.

### 2. Description of the Related Art

The energy density of a lithium-ion battery is determined by the voltage of a cell and the number of Li ions per cell volume (or mass) transported via electrochemical reactions. In the actual battery, irreversible electrochemical reduction of an electrolyte, which forms a solid-electrolyte interphase (SEI) on an anode, occurs during the initial cycle, which results in the consumption of active lithium ions loaded in a cathode prior to cycling. The available capacity and energy density of the battery are limited significantly in the next cycle due to the decreased active lithium ions. Whereas graphite, which is commonly used for an anode of a lithium-ion battery, generally exhibits a coulombic efficiency of about 90% of the initial value, the next-generation high-capacity anode material such as silicon or silicon oxide (SiOₓ) generally exhibits a coulombic efficiency of lower than 80% of the initial value. This makes commercialization difficult.

In order to achieve high initial coulombic efficiency and maximized energy density for commercialization, an attempt has been made to compensate for the loss of active lithium ions with excess lithium ions through prelithiation prior to battery assembly. Several prelithiation methods have been presented, including addition of lithium particles or lithium compounds in solid state as sacrificial lithium sources during an electrode preparation process, prelithiation through physical contact of lithium metal to a prepared electrode, electrochemical prelithiation of an electrode by preparing a temporary cell with an anode paired with a lithium metal counter electrode, etc. Recently, the inventors of the present disclosure have presented a prelithiation method using a reducing solution containing a linear or cyclic ether and have shown that initial coulombic efficiency can be increased to 100% via a chemical reaction of intercalating active lithium into a silicon-based anode.

The lithium-intercalated anode obtained through prelithiation exhibits high initial coulombic efficiency when used for battery assembly on its own. However, due to the low oxidation/reduction potential of the anode active material below 0.5 V (vs Li/Li⁺), unwanted side reactions occur upon exposure to dry air or contact with a solvent for preparation of an electrode slurry. This leads to increased resistance of the electrode and decreased initial coulombic efficiency and reversible capacity, thereby making commercialization difficult.

The inventors of the present disclosure have researched consistently on prelithiated high-capacity anode active materials or delithiation of anodes. As a result, they have prepared a delithiation solution with a reduction potential of 0.5-2.5 V (vs Li/Li⁺) by dissolving an aromatic hydrocarbon in a cyclic or linear ether-based solvent and have completed the present disclosure by finding out that it is possible to manufacture a commercializable lithium secondary battery having high initial coulombic efficiency and exhibiting high energy density even when exposed to dry air or solvents for preparation of an electrode slurry by chemically recovering lithium from a prelithiated anode active material or anode, and that the anode active material or anode can be formed.

### REFERENCES OF THE RELATED ART

### Non-Patent Documents

(Non-patent document 1) Holtstiege, F., Barmann, P., Nolle, R., Winter, M. & Placke, T. Pre-lithiation strategies for rechargeable energy storage technologies: Concepts, promises and challenges. Batteries 4, 4 (2018).

(Non-patent document 2) Sun, Y. et al. High-capacity battery cathode prelithiation to offset initial lithium loss. Nat. Energy 1, 1-7 (2016).

(Non-patent document 3) Choi, J. et al. Weakly Solvating Solution Enables Chemical Prelithiation of Graphite-SiOₓ Anodes for High-Energy Li-Ion Batteries. J. Am. Chem. Soc. 143, 9169-9176 (2021).

### SUMMARY

The present disclosure is directed to providing a method for recovering lithium from an anode active material or an anode using a delithiation solution and a method for chemically forming the anode active material or the anode therethrough.

In an aspect, the present disclosure provides a delithiation solution containing: a cyclic or linear ether-based solvent; and an aromatic hydrocarbon, which has a reduction potential of 0.5-2.5 V (vs Li/Li⁺).

In another aspect, the present disclosure provides an anode including an anode active material or an anode active material layer delithiated with the delithiation solution.

In another aspect, the present disclosure provides a method for forming an anode active material or an anode, which includes: (A) a step of preparing an anode with a lithium-intercalated anode active material or anode active material layer formed; and (B) a step of immersing the anode active material or the anode in a delithiation solution containing a cyclic or linear ether-based solvent and an aromatic hydrocarbon and having a reduction potential of 0.5-2.5 V (vs Li/Li⁺).

In another aspect, the present disclosure provides an anode active material or an anode formed by the method for forming an anode active material or an anode.

In another aspect, the present disclosure provides a lithium-ion battery including the formed anode active material or anode.

In another aspect, the present disclosure provides a method for recovering lithium from a waste battery, which includes: a step of separating an electrode from a waste battery; and a step of immersing the separated electrode in the delithiation solution.

By chemically extracting reactive lithium from the high-capacity anode active material or anode, which has high initial coulombic efficiency due to high lithium content but exhibits decreased stability in dry air or in a solvent for preparation of a slurry, the delithiation solution according to the present disclosure can improve stability, maintain high initial coulombic efficiency, and form an anode active material or an anode without electrochemical cycling. In addition, the delithiation solution may be used to recover lithium from a waste battery.

In addition, the method for forming an anode active material or an anode according to the present disclosure can greatly reduce the cost and time required for delivery after production of a lithium-ion battery because superior capacity and ideal initial coulombic efficiency of 85% or higher can be exhibited even without the formation cycles of repeated charge and discharge at low current density for 1-7 days or longer after the production of the lithium-ion battery. In addition, an anode prepared by applying an additional stabilization process has an initial coulombic efficiency of 80% or higher and is applicable to mass production because it retains superior stability even after exposure to dry air and contact with an electrolyte of a lithium-ion battery.

In addition, an anode active material or an anode formed by the method for forming an anode active material or an anode of the present disclosure can exhibit superior stability even after exposure to dry air and contact with a solvent frequently used in the industry for preparation of a slurry.

### BRIEF DESCRIPTION OF THE DRAWINGS

FIG. 1 schematically illustrates a method for chemically forming an anode active material or an anode according to an exemplary embodiment of the present disclosure.

FIG. 2 shows photographic images obtained during formation of an electrode in Example 1 according to the present disclosure.

FIG. 3 shows the electrochemical curves of (a) an electrode of Preparation Example 1, (b) a formed electrode of Example 1, (c) a formed electrode of Example 1 exposed to dry air, (d) a formed and stabilized electrode of Example 2 and (e) a formed and stabilized electrode of Example 2 exposed to dry air according to the present disclosure.

FIG. 4 shows the change of the initial coulombic efficiency of a prelithiated silicon oxide electrode of Preparation Example 1, a formed electrode of Example 1 and a formed and stabilized electrode of Example 2 of the present disclosure after exposure to dry air for 24 hours.

### DETAILED DESCRIPTION

Hereinafter, the present disclosure is described more specifically referring to the attached drawings and examples.

As described above, a lithium-intercalated anode active material or anode obtained through prelithiation exhibits increased electrode and significantly decreased initial coulombic efficiency and reversible capacity due to unwanted side reactions occurring upon exposure to dry air or contact with a solvent for preparation of an electrode slurry owing to the oxidation/reduction potential of the prelithiated anode active material lower than 0.5 V (vs Li/Li⁺). In addition, the prelithiated active material or electrode has limitation in that commercialization is difficult due to decreased processability and increased possibility of explosion owing to vigorous reaction with oxygen and trace of humidity. The present disclosure provides a delithiation solution which is capable of improving stability in dry air or during preparation of an electrode slurry by effectively re-extracting lithium, which is the cause of instability of a lithium-intercalated anode active material or anode, and chemically forming an anode active material or an anode therethrough.

More specifically, an aspect of the present disclosure provides a delithiation solution containing a cyclic or linear ether-based solvent and an aromatic hydrocarbon and having a reduction potential of 0.5-2.5 V (vs Li/Li⁺).

The delithiation solution of the present disclosure has a reduction potential of 0.5-2.5 V (vs Li/Li⁺). If the reduction potential of the delithiation solution is below 0.5 V (vs Li/Li⁺), lithium cannot be recovered from a silicon-based anode active material or anode. And, if the reduction potential of the delithiation solution exceeds 2.5 V (vs Li/Li⁺), initial coulombic efficiency may decrease because of unwanted side reactions. Therefore, lithium intercalated in the lithiated anode active material or anode may be effectively extracted and recovered when the reduction potential of the delithiation solution is 0.5-2.5 V (vs Li/Li⁺).

The solvent of the delithiation solution of the present disclosure may be a cyclic or linear ether-based solvent.

The cyclic ether-based solvent may be one or more selected from a group consisting of dioxolane, methyldioxolane, dimethyldioxolane, vinyldioxolane, methoxydioxolane, ethylmethyldioxolane, oxane, dioxane, trioxane, tetrahydrofuran, methyltetrahydrofuran, dimethyltetrahydrofuran, dimethoxytetrahydrofuran, ethoxytetrahydrofuran, ethyltetrahydrofuran, methyltetrahydropyran, dimethyltetrahydropyran, dihydropyran, tetrahydropyran, hexamethylene oxide, furan, dihydrofuran, dimethoxybenzene and dimethyloxetane.

The linear ether-based solvent may be one or more selected from a group consisting of dimethyl ether, diethyl ether, ethyl methyl ether, ethyl prophyl ether, diprophyl ether, diisoprophyl ether, dibutyl ether, diisobutyl ether, ethyl tert-butyl ether, dimethoxymethane, trimethoxymethane, dimethoxyethane, diethoxyethane, dimethoxypropane, diethylene glycol dimethyl ether, diethylene glycol ethyl methyl ether, diethylene glycol isopropyl methyl ether, diethylene glycol butyl methyl ether, diethylene glycol diethyl ether, diethylene glycol tert-butyl ethyl ether, triethylene glycol dimethyl ether, tetraethylene glycol dimethyl ether, ethylene glycol ethyl methyl ether, ethylene glycol divinyl ether, diethylene glycol divinyl ether and triethylene glycol divinyl ether.

The aromatic hydrocarbon may have a reduction potential higher than the electrochemical potential of the anode active material or anode for delithiation of the anode active material or anode. In addition, the aromatic hydrocarbon may be substituted or unsubstituted, and may be an aromatic hydrocarbon having 18 or less carbon atoms except a substituent. An aromatic hydrocarbon having more than 18 carbon atoms in the aromatic ring is undesirable because lithium cannot be recovered effectively from the prelithiated anode active material or anode due to insufficient complex formation with lithium owing to low solubility in the ether-based solvent. More specifically, the aromatic hydrocarbon may be substituted or unsubstituted naphthalene, anthracene, phenanthrene, tetracene, azulene, fluoranthene, pyrene, triphenylene, biphenyl, terphenyl, stilbene, etc. More specifically, substituted or unsubstituted anthracene may be used.

In particular, when the aromatic hydrocarbon is anthracene, oxidizing power enough to effectively recover lithium intercalated in the silicon-based anode active material or anode can be achieved because of a significantly higher reduction potential of about 0.9 V vs lithium metal.

The substituent of the substituted aromatic hydrocarbon may be one or more substituent selected from a C₁₋₆ alkyl group, a C₆₋₂₀ aryl group, a C₁₋₁₀ alkoxy group and a C₁₋₆ alkyl halide, more specifically a C₁₋₄ alkyl group.

The concentration of the aromatic hydrocarbon in the delithiation solution may be 0.01-0.2 M, specifically 0.03-0.15 M, more specifically 0.05-0.13 M. If the concentration of the aromatic hydrocarbon in the delithiation solution is below 0.01 M, the lithium intercalated in the anode active material or anode may not be recovered enough. Otherwise, if it exceeds 0.2 M, byproducts may be formed undesirably on the surface of the anode active material or anode due to precipitation of the aromatic hydrocarbon.

In addition, the present disclosure provides an anode including an anode active material or an anode active material layer delithiated with the delithiation solution.

The anode active material may be silicon, silicon oxide, a mixture of silicon and graphite, a mixture of silicon oxide and graphite, or a mixture of silicon oxide, silicon and graphite.

Because a lithium-ion battery can work only when lithium ions and electrons are activated, a formation process of activating the battery in advance is essential. The conventional electrochemical formation process requires repeated charge and discharge at low current density for 1-7 days or longer. However, this formation process has limitation in that the process is complicated and consumes a lot of cost and energy. The present disclosure provides a method for forming an anode active material or an anode using a delithiation solution.

More specifically, the present disclosure provides a method for forming an anode active material or an anode, which includes: (A) a step of preparing an anode with a lithium-intercalated anode active material or anode active material layer formed; and (B) a step of immersing the anode active material or the anode in a delithiation solution containing a cyclic or linear ether-based solvent and an aromatic hydrocarbon and having a reduction potential of 0.5-2.5 V (vs Li/Li⁺).

The method for forming an anode active material or an anode of the present disclosure provides a simple process of forming an anode active material or anode by immersing an anode with a lithium-intercalated anode active material or anode active material layer formed through prelithiation in a delithiation solution, and is applicable even to an anode active material in powder form. In addition, it is advantageous in that consumption of energy and cost is decreased significantly as compared to the conventional electrochemical formation method.

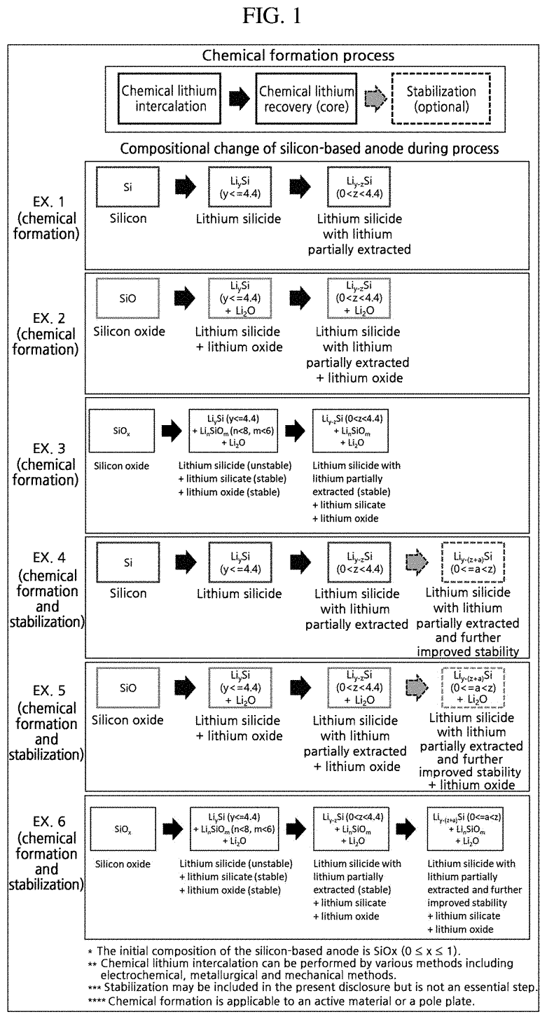

FIG. 1 schematically illustrates a method for forming an anode active material or an anode according to an exemplary embodiment of the present disclosure. Referring to the figure, the method for forming an anode active material or an anode according to the present disclosure may further include, after the step (B), (C) a step of immersing the lithium-extracted anode active material or anode obtained in the step (B) in a solution wherein a hydrocarbon containing a fluorine substituent is dissolved.

Hereinafter, each step of the method for forming an anode active material or an anode of the present disclosure is described in more detail.

(A) Preparation of Anode with Lithium-Intercalated Anode Active Material or Anode Active Material Layer Formed

The step (A) is a step of preparing a lithium-intercalated anode active material or anode. The conventional prelithiation methods such as addition of lithium particles or lithium compounds in solid state as sacrificial lithium sources, prelithiation through physical contact of lithium metal to a prepared electrode or electrochemical prelithiation of an electrode by preparing a temporary cell with an anode formed of lithium metal may be used. More specifically, a prelithiated anode active material or anode may be prepared using a prelithiation solution described below. The use of the prelithiation solution is advantageous in that lithium can be uniformly intercalated into the anode active material, the process is simple and it can be used for mass production of a lithium-ion battery.

More specifically, the step (A) may include (A1) a step of immersing the anode with anode active material or anode active material layer formed in a prelithiation solution containing a cyclic or linear ether-based solvent and a complex of a lithium ion and an aromatic hydrocarbon and having a reduction potential of lower than 0.25 V.

The prelithiation solution may exhibit a reduction potential of lower than 0.25 V, which is lower than that of the silicon-based anode, such that lithium can be intercalated into the silicon-based anode active material or anode owing to sufficiently high reducing power.

The aromatic hydrocarbon of the prelithiation solution may be substituted or unsubstituted, and may be a polycyclic aromatic compound having 10-22 carbon atoms except a substituent. If the aromatic hydrocarbon has less than 10 carbon atoms, complex formation between Li ion and the aromatic hydrocarbon derivative is impossible because the reduction potential is lower than that of Li. And, if the number of carbon atoms exceeds 22, enough reducing power cannot be achieved due to high oxidation/reduction potential.

The aromatic hydrocarbon of the prelithiation solution may be one or more selected from a group consisting of naphthalene, anthracene, phenanthrene, tetracene, azulene, fluoranthene, phenylanthracene, phenylene, pyrene, triphenylene, biphenyl, terphenyl and stilbene, specifically one or more selected from naphthalene and biphenyl.

The aromatic hydrocarbon of the prelithiation solution may contain one or more substituent selected from C₁₋₆ alkyl, C₆₋₂₀ aryl, C₁₋₁₀ alkoxy and C₁₋₆ alkyl halide. Specifically, it may contain C₁₋₄ alkyl as a substituent.

The aromatic hydrocarbon of the prelithiation solution may be one or more selected from a group consisting of the following compounds represented by Chemical Formula 1 and Chemical Formula 2.

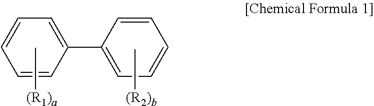

In Chemical Formula 1, each of R₁ and R₂, which are identical to or different from each other, is C₁₋₆ alkyl, C₆₋₂₀ aryl, C₁₋₁₀ alkoxy or C₁₋₆ alkyl halide and each of a and b is independently an integer from 0 to 5, with the proviso that at least one of them is not 0, if a is 2 or larger, two or more R₁'s are identical to or different from each other and, if b is 2 or larger, two or more R₂'s are identical to or different from each other. More specifically, in Chemical Formula 1, each of R₁ and R₂, which are identical to or different from each other, is C₁₋₄ alkyl and each of a and b is independently an integer from 0 to 2.

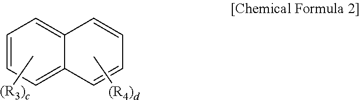

In Chemical Formula 2, each of R₃ and R₄, which are identical to or different from each other, is C₁₋₆ alkyl, C₆₋₂₀ aryl, C₁₋₁₀ alkoxy or C₁₋₆ alkyl halide and each of c and d is independently an integer from 0 to 5, with the proviso that at least one of them is not 0, if c is 2 or larger, two or more R₃'s are identical to or different from each other and, if d is 2 or larger, two or more R₄'s are identical to or different from each other. More specifically, in Chemical Formula 2, each of R₃ and R₄, which are identical to or different from each other, is C₁₋₄ alkyl and each of c and d is independently an integer from 0 to 2.

When Chemical Formula 1 and Chemical Formula 2 satisfy the above conditions, the prelithiation solution has the advantage that stability can be conferred to the electrode by forming a protective layer on the surface of the electrode. In addition, when Chemical Formula 1 and Chemical Formula 2 satisfy the more specific conditions, lithium can be effectively intercalated into the silicon-based anode due to sufficiently low reduction potential as compared to the silicon-based anode. Through this prelithiation, initial coulombic efficiency can be improved significantly.

According to a specific exemplary embodiment of the present disclosure, the aromatic hydrocarbon of the prelithiation solution may be one or more selected from a group consisting of the following compounds represented by Chemical Formulas 1-1 to 1-3 and Chemical Formulas 2-1 to 2-3.

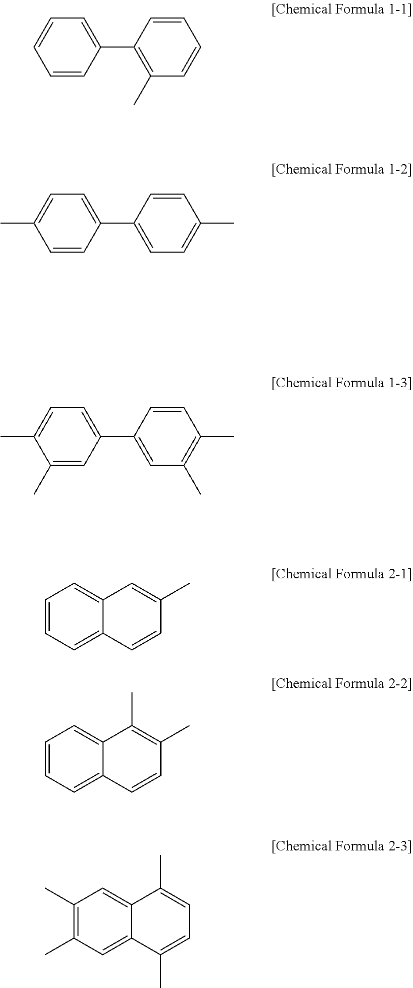

The prelithiation solution containing the aromatic hydrocarbon represented by Chemical Formulas 1-1 to 1-3 or Chemical Formulas 2-1 to 2-3 has reducing power sufficient for chemical prelithiation of a silicon-based anode with an oxidation/reduction potential of 0.2 V or lower and can exhibit an initial coulombic efficiency exceeding 100%. That is to say, almost the same charge capacity and discharge capacity can be achieved by successfully compensating the irreversible lithium loss of the pure SiOx anode.

The solvent of the prelithiation solution is the same as the solvent used in the delithiation solution described above.

When the anode active material or anode is graphite or a graphite complex, the cyclic or linear ether-based solvent of the prelithiation solution may have an oxygen-to-carbon ratio of 0.25 or lower. If a cyclic or linear ether-based solvent having high solvation power, with the oxygen-to-carbon ratio of the cyclic or linear ether-based solvent exceeding 0.25, is used, processing of a high-capacity anode such as graphite, graphite complex, etc. is impossible. Therefore, it is preferred that the solvent has an oxygen-to-carbon ratio of 0.25 or lower (O:C≤0.25). That is to say, since the co-intercalation of large-sized solvated lithium ions causes the exfoliation of graphite, it is necessary to allow the intercalation (doping) of desolvated lithium ions only while preventing the co-intercalation of the solvated lithium ions into graphite. In addition, when the oxygen-to-carbon ratio of the ether-based solvent is 0.25 or lower, it is advantageous in that prelithiation is possible even with a hydrocarbon with no substituent because the reduction potential is low enough due to weak solvation power.

As the cyclic ether-based solvent having an oxygen-to-carbon ratio of 0.25 or lower, one or more selected from a group consisting of methyldioxolane, dimethyldioxolane, vinyldioxolane, ethylmethyldioxolane, oxane, tetrahydrofuran, methyltetrahydrofuran, dimethyltetrahydrofuran, ethoxytetrahydrofuran, ethyltetrahydrofuran, dihydropyran, tetrahydropyran, methyltetrahydropyran, dimethyltetrahydropyran, hexamethylene oxide, furan, dihydrofuran, dimethoxybenzene and dimethyloxetane may be used. More specifically, methyltetrahydrofuran or tetrahydropyran may be used.

In addition, as the linear ether-based solvent having an oxygen-to-carbon ratio of 0.25 or lower, one or more selected from a group consisting of ethylene glycol dibutyl ether, methoxypropane, ethyl prophyl ether, diethyl ether, ethyl prophyl ether, diprophyl ether, diisoprophyl ether, dibutyl ether, diisobutyl ether and ethyl tert-butyl ether may be used.

The concentration of the complex in the prelithiation solution may be 0.01-5 M, specifically 0.1-2 M, more specifically 0.2-1 M.

The immersion in the step (A1) may be performed at −10 to 80° C., specifically at 10-50° C. At the temperature range of −10 to 80° C., the oxidation/reduction potential of the complex is decreased typically, and the improved reducing power may result in improved initial coulombic efficiency. If the immersion in the step (A1) is performed at a temperature below −10° C., prelithiation reaction may not occur due to excessively high oxidation/reduction potential. And, if the immersion is performed at a temperature above 80° C., precipitation of lithium metal may occur.

The immersion in the step (A1) may be performed for 0.01-1440 minutes, specifically for 1-600 minutes, more specifically for 5-240 minutes. The initial coulombic efficiency of the prepared anode is increased rapidly until 5 minutes after the immersion. The rate of increase is decreased gradually from 30 minutes, and the initial coulombic efficiency is maintained without being increased any more from 120 minutes. The cell open-circuit voltage (OCV) shows a tendency opposite to that of the initial coulombic efficiency. Therefore, if the immersion time is shorter than 0.01 minute, it is difficult to expect the improvement of the anode performance through the prelithiation. And, even if the immersion time is longer than 1440 minutes, any more improvement in initial coulombic efficiency, decrease of OCV, etc. cannot be expected.

In the step (A1), the molar ratio of the anode active material immersed in the prelithiation solution and the complex in the prelithiation solution may be 1:0.1-1:20, specifically 1:1-1:15, more specifically 1:2-1:10. Prelithiation can be achieved successfully when the molar ratio of the anode active material and the complex is 1:0.1-1:20, and the most ideal initial coulombic efficiency can be achieved at a molar ratio of 1:2-1:10.

The step (A1) may be performed continuously by a roll-to-roll process. More specifically, the roll-to-roll process is performed by a roll-to-roll facility including an unwinder which continuously unwinds the anode and a rewinder which continuously rewinds the anode after the process is finished. The unwinder and the rewinder provide tension to the anode for a lithium-ion battery. The anode is supplied continuously by the unwinder and the rewinder, and prelithiation is conducted as the supplied anode passes through a prelithiation solution accommodation unit which accommodates the prelithiation solution and is immersed in the prelithiation solution. The anode that has passed through the prelithiation solution accommodation unit is rewound by the rewinder. The immersion time in the prelithiation solution may be adjusted by changing the speed of the roll-to-roll process or the number, position, etc. of the rolls. After the prelithiation, the anode may pass through an additional solution accommodation unit for washing and may pass through a drier for removal of the residual solution. The prelithiation solution used in the preparation method of the present disclosure is advantageous in that it can be applied to a roll-to-roll process capable of mass production since a protective layer is formed on the surface of the anode and stability can be maintained for a long time even in dry air.

(B) Immersion of Anode Active Material or Anode in Delithiation Solution Containing Cyclic or Linear Ether-Based Solvent and Aromatic Hydrocarbon and Having Reduction Potential of 0.5-2.5 V (vs Li/Li⁺)

The delithiation solution and the anode active material in the step (B) are the same as those described above.

The immersion in the step (B) may be performed at −10 to 80° C., specifically at 10-50° C. If the immersion in the step (B) is performed at a temperature below −10° C., delithiation reaction may be delayed. And, if the immersion is performed at a temperature above 80° C., the ether solvent may be evaporated.

The immersion in the step (B) may be performed for 0.01-1440 minutes, specifically for 1-600 minutes, more specifically for 5-240 minutes. If the immersion time is shorter than 0.01 minute, it is difficult to expect the effect of reduction of side reactions upon exposure to dry air or contact with a solvent for preparation of an electrode slurry owing to improved stability. And, if the immersion time is longer than 1440 minutes, no more improvement in initial coulombic efficiency, decrease of OCV, etc. can be expected.

In the step (B), the molar ratio of the anode active material immersed in the delithiation solution and the aromatic hydrocarbon in the delithiation solution may be 1:0.1-1:100, specifically 1:1-1:50, more specifically 1:2-1:20, most specifically 1:4-1:10. Delithiation can be achieved successfully when the molar ratio of the anode active material and the aromatic hydrocarbon is 1:0.1-1:100, and the most ideal dry air stability can be ensured at a molar ratio of 1:4-1:10.

The step (B) may be performed continuously by a roll-to-roll process. Similarly to the roll-to-roll process of the step (A1) described above, the anode is supplied continuously by an unwinder a rewinder. The supplied anode passes through a delithiation solution accommodation unit which accommodates the delithiation solution and is immersed in the delithiation solution. The anode that has passed through the delithiation solution accommodation unit is rewound by the rewinder. The delithiation solution used in the preparation method of the present disclosure is advantageous in that it can be applied to a roll-to-roll process capable of mass production since stability can be maintained for a long time even in dry air because highly reactive lithium has been extracted out of the reactive lithiated anode materials including lithium silicide and lithiated graphite.

(C) Immersion of Lithium-Extracted Anode Active Material or Anode Obtained in Step (B) in Solution in Which Hydrocarbon Containing Fluorine Substituent is Dissolved

The step (C) is a step wherein the anode active material or anode with lithium extracted and recovered in the step (B) is stabilized. The anode active material or anode delithiated in the step (C) has an initial coulombic efficiency of 80% or higher, and is applicable to mass production since it maintains superior stability even after contact with dry air or an electrolyte of a lithium-ion battery.

The hydrocarbon containing a fluorine substituent may be fluoroethylene carbonate, fluorodecane or fluorobenzene.

In addition, the present disclosure provides an anode active material or an anode formed by the method for forming an anode active material or an anode described above.

The anode active material or anode formed according to the present disclosure is improved in terms of side reactions and performance decline upon exposure to dry air or during preparation of an electrode slurry owing to remarkably decreased reactivity. Therefore, it can be applied to a large-scale production process of lithium secondary batteries.

In addition, the present disclosure provides a lithium-ion battery including the formed anode active material or anode.

In addition, the present disclosure provides a method for recovering lithium from a waste battery, which includes: a step of separating an electrode from a waste battery; and immersing the separated electrode in the delithiation solution described above.

It is necessary to recover lithium from lithium-ion batteries that have been wasted after use or defective lithium-ion batteries (waste batteries) in the aspects of resource saving and environmental protection. The method for recovering lithium from a waste battery according to the present disclosure allows recovery of lithium from a waste battery via a simple process using only the delithiation solution.

In addition, the present disclosure provides a method for safely recovering residual lithium metal powder and fragments remaining after use of a lithium-metal battery or an all-solid-state battery using lithium metal as an anode. Lithium metal in fine powder has the high risk of fire and explosion due to high reactivity. By stabilizing the instable lithium metal powder and fragments with the delithiation solution described above, lithium can be recovered in the form of a lithium-aromatic hydrocarbon complex solution without the risk of explosion.

Hereinafter, specific examples are described to help understanding the present disclosure. However, the examples are presented to describe the present disclosure in more detail, and it will be obvious to those having ordinary knowledge in the art that the scope of the present disclosure is not limited by them and various changes and modifications can be made within the scope and technical idea of the present disclosure.

### PREPARATION EXAMPLE 1

Silicon Oxide Electrode

An electrode slurry was prepared by mixing silicon oxide as an active material with carbon black and a binder in distilled water at a weight ratio of 7:1.8:1.2 using a centrifuge (THINKY Corporation, Japan). The slurry was cast on a Cu foil current collector and dried at 80° C. for 1 hour. After conducting roll-pressing and cutting to a diameter of 11.3 mm (area: 1.003 cm²), the slurry was dried overnight in a vacuum oven at 120° C. The loading amount of the active material on each electrode was 1.0±0.5 mg/cm².

Prelithiated Silicon Oxide Electrode

The prepared electrode was immersed for 30 minutes in a prelithiation solution prepared by mixing 0.5 M lithium-biphenyl (Li-BP) with 2-MeTHF (at 30° C.). Then, a prelithiated silicon oxide electrode was prepared by washing with 2-MeTHF and intercalating lithium. The molar ratio of the active material (silicon oxide) and the lithium-biphenyl (Li-BP) in the prelithiation solution was 1:8.

### EXAMPLE 1

Preparation of Delithiation Solution

After dissolving 0.08 M anthracene (ATC), which is an aromatic hydrocarbon, in a 2-methyltetrahydrofuran (2-MeTHF) solvent, a delithiation solution was prepared by stirring for 30 minutes in a glovebox at 45° C. under argon atmosphere.

Preparation of Formed (Delithiated) Electrode

Then, after immersing the prelithiated silicon oxide electrode of Preparation Example 1 in the delithiation solution, a formed electrode was prepared by quenching further reaction between the delithiation solution and the electrode by washing with a 2-MeTHF solvent. The molar ratio of the active material (silicon oxide) and the anthracene (ATC) in the delithiation solution was 1:8.

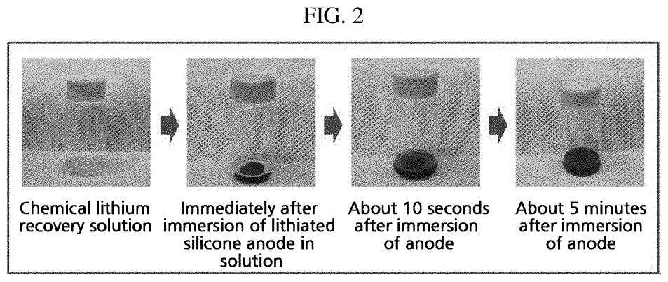

FIG. 2 shows photographic images obtained during the formation of the electrode of Example 1 according to the present disclosure. From FIG. 2, it can be seen that, when the prelithiated silicon oxide electrode was immersed in the delithiation solution, the transparent delithiation solution (ATC) turned to a blue black Li-ATC solution, suggesting that lithium was extracted.

### EXAMPLE 2

Preparation of Stabilization Solution

After dissolving 50 vol % of fluorobenzene in a cyclohexane solvent, a stabilization solution was prepared by stirring for 30 minutes in a glovebox at 30° C. under argon atmosphere.

Preparation of Formed and Stabilized Electrode

A formed and stabilized electrode was prepared by stabilizing the surface of the formed electrode prepared in Example 1 by immersing in the prepared stabilization solution and thereby quenching reaction with dry air.

### EXAMPLE 3

A formed electrode was prepared in the same manner as in Example 1 except that 9-methylanthracene (9-MeATC) was used as an aromatic hydrocarbon for preparing the delithiation solution.

### EXAMPLE 4

After immersing silicon oxide active material powder for 30 minutes in a prelithiation solution prepared by mixing 0.5 M lithium-biphenyl (Li-BP) with 2-MeTHF, prelithiated silicon oxide active material powder was prepared by washing with 2-MeTHF and intercalating lithium. The molar ratio of the active material (silicon oxide) and the lithium-biphenyl (Li-BP) in the prelithiation solution was 1:8.

Then, after immersing the lithiated silicon oxide active material powder in a delithiation solution prepared in the same manner as in Example 1 and stirring for 30 minutes, formed silicon oxide active material powder was prepared by extracting lithium through filtering.

### EXAMPLE 5

A formed and stabilized silicon oxide active material powder was prepared by immersing the powder prepared in Example 4 in the stabilization solution prepared in Example 2.

### EXAMPLE 6

A slurry prepared by mixing the formed and stabilized active material powder prepared in Example 5 with conductive carbon and a polymer binder in a tetrahydrofuran (THF) solvent was applied on a copper foil using a doctor blade. Then, an electrode was prepared by drying in a vacuum oven at 80° C. so that THF was evaporated sufficiently.

### TEST EXAMPLE 1

### Electrochemical Analysis

A CR2032 coin cell was prepared in a glovebox under argon atmosphere using PP/PE/PP as a separator and 1 M LiPF₆ mixed in ethylene carbonate (EC) and diethyl carbonate (DEC) (1:1 v/v) as an electrolyte. A half-cell experiment was conducted using the electrodes prepared in Preparation Example and Examples 1-6 as a working electrode. In the half-cell experiment, the coin cell was discharged to +30 mV vs the reduction potential of lithium under constant current, discharged further to the end voltage until the current density was decreased to 10% of the original value under constant voltage, and then charged to 1.2 V. The current density during the first two cycles and subsequent cycles was 0.2 C and 0.5 C vs reversible capacity, respectively. Electrochemical analysis was conducted using a WBCS-3000 battery cycler (Wonatech Co. Ltd., Korea) and a VMP3 potentio/galvanostat (BioLogic Scientific Instruments, France). All electrochemical analysis was conducted at 30° C.

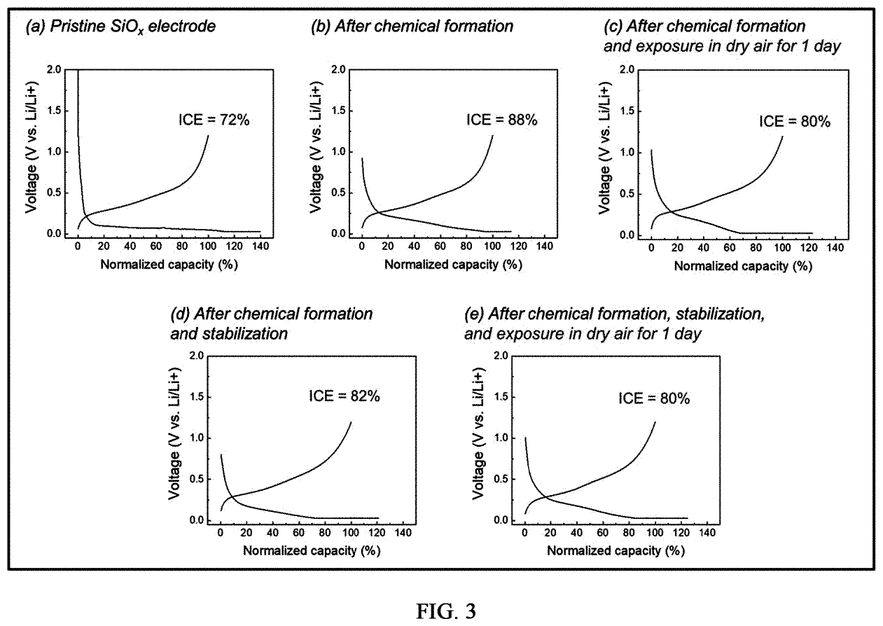

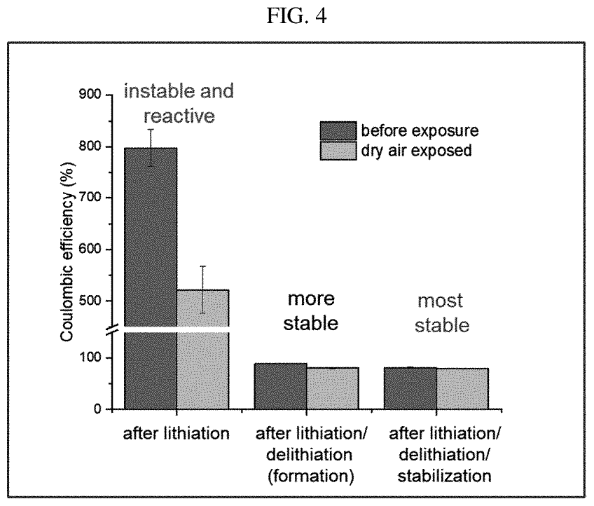

In order to observe the change in the performance of the electrodes prepared in Preparation Example 1 and Examples 1-2 after exposure to dry air, they were exposed to a dry room with a dew point of −50° C. or below for 24 hours, and electrochemical performance was evaluated before and after the exposure. The result is shown in FIG. 3 and FIG. 4.

FIG. 3 shows the electrochemical curves of (a) the electrode of Preparation Example 1, (b) the formed electrode of Example 1, (c) the formed electrode of Example 1 exposed to dry air, (d) the formed and stabilized electrode of Example 2 and (e) the formed and stabilized electrode of Example 2 exposed to dry air according to the present disclosure.

From FIG. 3, it can be seen that, whereas the pure silicon oxide electrode (Preparation Example 1) exhibited an initial coulombic efficiency of 72%, the formed electrode of Example 1 and the formed and stabilized electrode of Example 2 showed higher initial coulombic efficiency than the pure silicon oxide electrode as 88% and 82%, respectively. It can also be seen that they showed initial coulombic efficiency higher by 8% than the pure silicon oxide electrode even after exposure to dry air for one day. Through this, it can be seen that the electrodes of Example 1 and Example 2 were successfully formed chemically. In addition, it was confirmed that structural destruction did not occur during the chemical formation of silicon oxide since the electrodes of Example 1 and Example 2 showed curves of the same shape as that of pure silicon oxide.

FIG. 4 shows the change of the initial coulombic efficiency of the prelithiated silicon oxide electrode of Preparation Example 1, the formed electrode of Example 1 and the formed and stabilized electrode of Example 2 of the present disclosure after exposure to dry air for 24 hours. As seen from FIG. 4, the prelithiated silicon oxide electrode of Preparation Example 1 showed rapid decreased in initial coulombic efficiency from about 800% to 520% by 35% (280%p) after exposure to dry air. This means that the prelithiated electrode reacted vigorously with dry air. In contrast, the electrodes prepared in Examples 1-2 showed relatively less change in initial coulombic efficiency after exposure to dry air. Through this, it can be seen that, whereas the prelithiated electrode exhibits decreased processability during mass production and has the risk of explosion, etc., the electrode formed using the delithiation solution according to the present disclosure exhibits significantly improved processability during battery production with no risk of explosion at all owing to remarkably decreased reactivity with dry air.

What is claimed is:

1. A delithiation solution comprising:
a cyclic or linear ether-based solvent; and
an aromatic hydrocarbon,
which has a reduction potential of 0.5-2.5 V (vs Li/Li⁺).

2. The delithiation solution according to claim 1, wherein the aromatic hydrocarbon is an aromatic hydrocarbon having 18 or less carbon atoms except a substituent.

3. The delithiation solution according to claim 1, wherein the aromatic hydrocarbon is one or more selected from a group consisting of substituted or unsubstituted naphthalene, anthracene, phenanthrene, tetracene, azulene, fluoranthene, pyrene, triphenylene, biphenyl, terphenyl and stilbene.

4. The delithiation solution according to claim 1, wherein the concentration of the aromatic hydrocarbon in the delithiation solution is 0.01-0.2 M.

5. An anode comprising an anode active material or an anode active material layer delithiated with the delithiation solution according to claim 1.

6. The anode comprising an anode active material or an anode active material layer according to claim 5, wherein the anode active material is silicon, silicon oxide, a mixture of silicon and graphite, a mixture of silicon oxide and graphite, or a mixture of silicon oxide, silicon and graphite.
